(19) United States
(12) Patent Application Publication
(10) Pub. No.: US 2010/0114968 A1
(43) Pub. Date: May 6, 2010

(54) SYSTEM FOR COMMUNICATION OF ATTENDEE DATA

(76) Inventor: ROBERT DEAN, Melling (GB)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/256,086

(22) Filed: Oct. 22, 2008

(51) Int. Cl. G06F 17/30; G06F 7/00

(52) U.S. Cl. 707/796; 707/E17.032

(57) ABSTRACT

A system by which a service provider administers data pertaining to attendees of an event hosted at a venue, including a data store and a network connection associated with the service provider. The data store includes profile data for a plurality of users. User identification media is issued to a user upon registration of user profile information with the service provider, which media carries the user identification data. A reader device at the venue determines user identification data carried by said media. The reader device transmits an identification data signal to the service provider upon determination of the user's identification data, wherein the service provider searches said data store for the user's profile data, and transmits a return data signal to said venue that includes music preference data retrieved from said user profile data. The electronic apparatus at the venue compiles received music preference data from the service provider.

### BACKGROUND

The present invention relates to a system and method for communication of data pertaining to attendees of an event, and more particularly, although not exclusively, to a system and method which allows music preferences to be associated with attendance at an event or venue by a user.

In light of the popularity of social networking services in recent years, it has been recognized that music preferences are often a significant factor in determining how users portray themselves or assess others. It is well known that a significant portion of users list music preferences as one of the most important defining factors of an individual's character. Accordingly, a number of social networking sites have been established which focus predominantly on musical interests and preferences.

For a majority of music lovers, the physical attendance of music events such as gigs, music festivals, concerts, nightclubs and the like is the best way to appreciate music and to interact with other people who share similar musical tastes. Friendships between individuals are often formed or strengthened by the shared experience of attending music events.

Whilst it is generally known that users of social networking sites and the like can enter groups or discussion forums relating to music events, there is currently little way of associating individual's music tastes with the physical event itself. It is not uncommon for groups of individuals who have attended an event to want to share information after a music event, such as photographs and stories.

However, the actual attendance of the event is generally a passive experience in which individuals can only hope that their own musical preferences will be catered for based upon promotional material for the event such as flyers, adverts, announcements and the like. This is evident, for example, at gigs when fans shout out titles of songs they wish to here in an attempt to steer the proceedings towards their own musical tastes.

In the case of nightclubs and dance events, a disc jockey must attempt to assess the attitude and wishes of the crowd in order to deliver a music set which matches the event. Less experienced disc jockeys will often arrive with a predetermined set of songs that they wish to play, whilst a more experienced disc jockey will tend to bring a large collection of music, from which they can select songs dynamically to match the mood of the crowd.

Given the above factors, it will be appreciated that it not a simple matter to cater for a majority of attendees at a music event. Furthermore, despite the popularity of music-based social networking sites, little has been done to cater specifically for the attendance of music events, which, for many individuals, is a primary focus of their love of music. Thus users are forced to use existing general tools to communicate information relating to the attendance of an event or venue, which are not tailored to that specific purpose.

This can lead to a fragmented recordal of an event, for which a number of individuals may establish web pages or social groups relating to an event. Thus it can be difficult for individuals to ascertain which web site represents an official resource for the event. It is also extremely difficult for event organizers to ensure that event-goers are directed to the correct resource for the purpose of communicating about the event, obtaining feedback and the like.

It is an aim of the present invention to improve the manner in which individuals can interact with an event and/or share information with others having an interest in the same event.

### SUMMARY OF THE INVENTION

According to a first aspect of the present invention, there is provided a system, a method and associated media for registering attendance at an event such that a user's preferences can be associated with the event. This may happen in real time such that the user's preferences can be transmitted to hardware at the event venue whilst the user is attending the event.

The user preferences to be associated with the event may comprise music preferences which may be stored against profile data for a user by a service provide at a location remote from the venue. User music preferences may be transmitted from the service provider's server to an event organizer server for automatic compilation into one or more master arrays of information relating to the combined preferences of users attending the event. A master playlist of songs may be generated for use by a disc jockey or event organizer.

The event venue may have a reader device capable of reading personal identification media carried by a user. Thus a user may log attendance at an event by allowing the personal identification media to be read. The personal identification media may have data pertaining to a personal identification code which is stored by the service provider. The data on the personal identification media may be encoded for decoding by the reader.

The system may comprise a swipe card system for identification of individual users. A personal identification media device such as an ID card having a bar code or magnetic strip thereon may be provided to the user by the service provider.

The user may be required to register personal profile data with the service provider prior to being issued with personal identification media. Attendance at an event may be logged by virtue of the time and date of a user ID being recognized at a particular venue which coincides with the time, date and venue recorded with the service provider for a particular event.

An event may be recorded with the service provider in order to allow a record of attendance to be created and stored. User preference data may be transmitted to the event or venue server from the service provider without also transmitting personal identification data for individual users.

In one embodiment, the registration of an event with the service provider may generate a resource such as an automatic web page for the event according to a predetermined template. Certain fields within the template may be automatically populated based upon data already stored by the service provider or else may be populated by the event organizer over a network. The service provider may administer the creation of the web site to ensure that only one web site is generated for each event by the service provider. The service provider may require an individual or company such as an event organizer or venue owner to register as a client by fulfilling a registration process prior to enabling the creation of a web resource for the event. The system may only initiate creation of an event resource in response to a request generated at the event venue location.

The event and venue web pages may be linked to personal profiles of individual users of a social networking facility such that the event pages can be accessed and interacted with by users of the social network. Users may upload media files and/or text to the event web pages. The service provider may administer levels of authorization for the event web page such that only authorized users can access or amend certain protected fields or upload media files to the event page. The different levels of authorization may comprise any or any combination of registered users, authorized users, event organizers or venue users; and/or clients (venue owners or administrators).

Software running on a registered user's computer may determine music preferences by monitoring music files accessed or played by a user. Such data may be uploaded to the service provider for appending to user profile data stored by the service provider.

In one embodiment, a voting system may be established by the service provider, in which registered users may vote or rank the content of media files uploaded to event web sites by other users. The service provider may administer rewards for users who have uploaded media files in accordance with predetermined reward criteria.

According to a further aspect of the invention, there is provided a method and system for administering an event or venue resource for access by users over a network.

### BRIEF DESCRIPTION OF THE DRAWINGS

Working embodiments of the present invention are described in further detail below with reference to the accompanying drawings, of which:

FIG. 1 shows a schematic of the basic components of one embodiment of the invention to be used at an event;

FIG. 2 shows a schematic of the basic components for implementation of one embodiment of the invention over a communication network;

FIG. 3 shows steps for creating a venue entry according to one embodiment of the invention;

FIG. 4 shows steps for creating an user-accessible resource for an event;

FIG. 5 shows steps involved in implementing the integration of user music preferences at a venue or event according to one embodiment of the invention;

FIG. 6 shows steps for sharing information relating to an event according to one embodiment of the invention; and,

FIG. 7 shows steps for offering incentive schemes according to one embodiment of the invention.

### DETAILED DESCRIPTION OF THE PREFERRED EMBODIMENTS

The embodiments of the present invention described below are directed to a system, method and associated apparatus for allowing members of a service to disseminate or exchange information with other members relating to an event and to contribute information towards the event itself in an effective manner. It is envisaged that the primary use of the present invention will be in relation to music preferences and attendance of music-related events such as performances, discos, gigs, concerts, music festivals, parties or other organized events. However, other social and business uses are not excluded and may include events such as exhibitions, trade fairs, public displays, artistic performances and/or other social gatherings.

The invention also provides a system for venues to be able to offer benefits to users without the need to acquire the personal details of the recipient as result of them submitting their music preferences to venues.

It will be appreciated that an event may be attributed to a particular venue or else may move from venue to venue on different dates. In such instances, an event may encompass a time period at the venue in which the event is held. However, it will also be appreciated that an event may comprise a number of coordinated occasions in a plurality of venues or locations which may happen simultaneously or else at different times. Thus an event may or may not be tied to any one location or single time period.

For ease of reference, the following description proceeds in relation to an event which takes place at a single venue for a predetermined duration such as a day or else a number of hours.

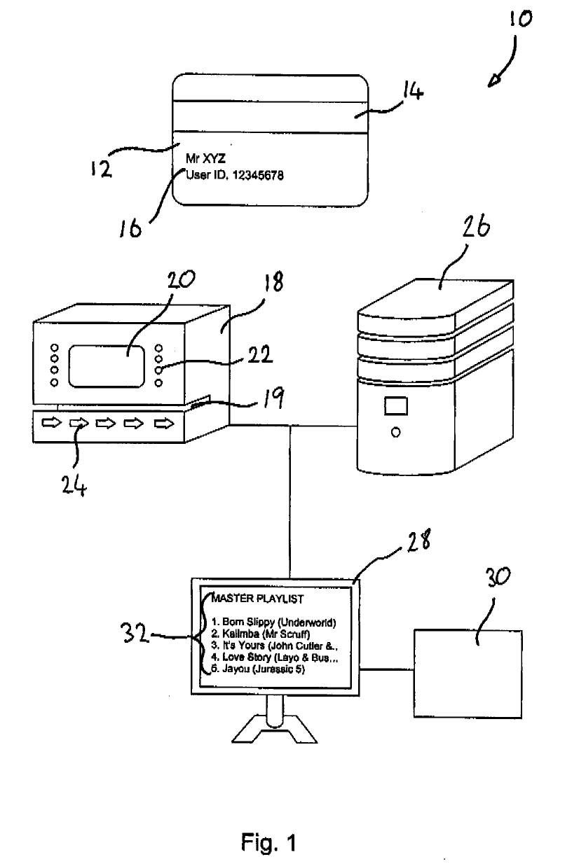

Turning firstly to FIG. 1, there is shown apparatus 10 for use at an event in accordance with the invention. The apparatus 10 comprises a data carrier in the form of user identification media 12 which, in this embodiment, takes the form of an identification card 12 having user identification data stored thereon. The data is typically stored in an encoded format.

The card 12 has a magnetic strip, on which data relating to the user is stored. The card may take the form of a conventional plastic card of the type used for debit cards, credit cards, store cards or the like. The card may also have user indicia 16 thereon specific to the individual registered to use the card as will be described in further detail below. The indicia may comprise text, an image and/or graphic representation enabling unique visual identification of the user. In this instance the user name and/or an ID number or code may be provided on the card.

The card will also typically comprise text and/or graphics identifying the service provider and/or event to be attended.

It will be apparent that various alternative types of data storage media and devices are widely available and may provide alternatives to the swipe card system described here in accordance with the present invention. For example, the card may be provided with a chip to be read by a reader device for recognition of an individual. In addition, key fobs or other data carriers and associated readers may also be suitable for use in conjunction with the present invention. In a further embodiment, the an electronic device having a power source and a memory may be provided for storage and transmission of user data.

RFID technology of this type is known in the art and RFID transmitters and receivers may be used in place of the card and reader technology shown in FIG. 1. Such technology may be of particular benefit if embedded in other consumer devices such as mobile telephones, PDA's, key fobs or the like.

User identification apparatus is provided at the venue where an event is to be held, which takes the form of a reader device 18, which is responsible for decoding the user identification media. A swipe card reader is provided in this instance and comprises a slot 19 shaped to receive a portion of a card 12 such that the user identification media can be read upon insertion of the card into the slot. The reader device 18 additionally comprises a display screen for presentation of information such as for example, the time and/or date, promotional advertising or else instructions for use of the device.

The device also comprises a number of keys 22 in order to allow the user to make manual selections relating to on-screen options. The keys 22 may take the form of a keypad. In one embodiment, a user may be required to provide manual input of a code associated with the user identification media in order to register their attendance at the venue.

Indicia 24 may also be provided on the device in order to aid a user to operate the device correctly.

The swipe card system has been decided upon in this embodiment since it provides for a low cost and simple implementation of the invention with a reasonable level of security for the user. It will be appreciated that the user information being transferred by way of the present invention need not comprise particularly sensitive data and thus more sophisticated levels of security may not be required. It is considered to be an advantage of the present invention that sensitive personal data for a user need not be stored on the identification media or transmitted to the venue apparatus in order for the system to be put into effect as will be described in further detail below. For this purpose a magnetic strip or bar code is considered a suitable data carrier.

The user identification apparatus 18 is connected to a processing means such as a PC. In this instance the processing means takes the form of a server device 26 which is adapted to be connected to a network. The server comprises a processor; a memory such as a hard disc or other suitable non-volatile memory; and network adapter to allow connection to a network such as a local area network, a wide area network and/or the world wide web. Such technology and the associated RAM and ROM requirements are well known to the skilled person and will not be described in detail here.

The user identification device and/or processing means are connected to a separate display 28. The display screen 28 is intended to be located for viewing by a person contributing towards the event, such as a performer, an organizer, an official or the like. In one embodiment, the display screen 28 is connected to, or else integral with, music production, mixing or broadcasting equipment 30. For example the display screen may be associated with a mixer for use by a disc jockey or else may be located on stage for a live music performance such that it can be seen by a performing artist or else their promoter or manager.

The processing means 26, display screen 28 and user identification device 18 may be provided as a single unit within a common housing or else may be provided as separate individual components which may be wired or wirelessly connected as required.

The display screen is arranged to display information relating to the individuals who have registered their attendance at the event via the user identification apparatus 18 as will be described below. The processor 26 is provided with machine readable instructions in the form of one or more computer programs (referred to hereinafter as client software) for processing data relating to the registered users and outputting information relating to the collected user data to display screen 28.

It is intended that the processor 26 will analyze data pertaining to a number of individuals for output of information such as tables, graphs, charts or textual information to the display 28, rather than information relating to any one individual alone. In the example shown in FIG. 1, the server 26 outputs a master playlist 32 to the screen 28 based upon the music preferences of the registered individuals at the event.

The client software may be provided for storage on device 26 by way of any form of known media such as on a data carrier, which may comprise a compact disk, a digital versatile disk, a hard disk, a memory stick or the like, or else a wireless or wired data signal.

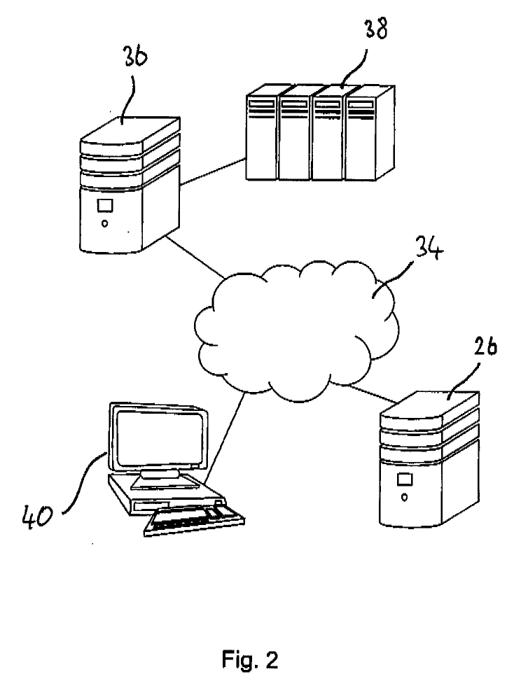

Turning now to FIG. 2, there is shown the basic hardware components which allow the present invention to be administered by a service provider for a plurality of clients. The client server 26 is connected to the service provider hardware over a network. In this embodiment, the connection is made via the internet 34 although any network capable of transmission of data signals could be used.

In the embodiment that the client server 26 is integral with, or else provided with, the user identification apparatus 18, then the service provider may have ownership of the hardware located at the client venue such that they can establish a secure WAN for administration of the system. The service provider may rent or lease the relevant proprietary equipment to a client.

The service provider hardware comprises means for establishing connection with the network (the internet 34) and administering the transmission and receipt of data signals with clients and individual users over the internet. In this regard the service provider hardware typically comprises one or more servers 36 which host one or more web sites which are accessible over the internet. The service provider hardware may specifically be assigned the tasks of creating venue accounts, creating and making available event resources such as a web site, associating users with attended events and compiling master play lists for an event.

The server machine 36 is provided with machine readable instructions in the form of proprietary software to allow the communication of data and the establishment of bespoke web pages in accordance with the present invention as will be described below.

The service provider hardware also comprises a non-volatile data store 38. The data store 38 typically comprises conventional mass storage media comprising a file system for storing and retrieving machine-readable data for administration by the service provider. The client hardware may facilitate the provision of a social networking web site such that individual users can register profile details with the service provider over the internet and thereby establish a user account.

A user will typically access the service provider's web site using conventional computing means 40 such as a PC, laptop, notebook, PDA or other portable or static electronic device capable of establishing a wired or wireless connection with the internet for communication of data signals. It will be appreciated that more recent developments in communication technology allow for the use of a variety of electronic devices for this purpose such as mobile/cell phones, set top boxes, satellite navigation devices, portable media players and the like, as well as electronics embedded in other data processing equipment.

A software plug-in may be installed on user's personal computer for interfacing with audio players on that PC for performing track submission. The software plug-in may include one or more modules of code for recognition of tracks played by the user via the PC. Such details may be logged for review by the user for amending their user profile or may be automatically uploaded to the user track listing on the server when a user next logs into their profile with the service provider. A user may then edit their track listings online.

It will be appreciated that a distinction between an individual user and a client is drawn for clarity of explanation of the present invention. An individual user will typically access the web site for social networking purposes and/or information gathering in a manner akin to conventional social networking web sites. Thus individual users will be required to submit personal profile details over the internet with the service provider in order to establish a user account.

The user profile details may include any or any combination of the following:
User name
User email address
User residential/postal address
User password
User date of birth (DOB)
User physical attributes
User ethnicity
User music preferences
User bank or credit/debit card details

The above criteria are provided only as examples and it will be appreciated that any other personal profile details may be required to establish an account. It is intended that payment in respect of subscription to the service will not be required but such an option is not excluded. A user's payment details may also be required in the event that the service allows for purchase of tickets to events or other merchandise over the internet.

In common with other social networking sites, the user may also be required to provide security details for use in establishing the identity of the user in the event that they forget their password. In addition, there will typically be the option of entering a significant amount of information about the user relating to their personal or social preferences, attitudes and opinions. All such data can be stored on mass storage device 38 by the service provider for retrieval by the registered user.

In this embodiment, the service provider provides for the storage of music preferences including information relating to any or any combination of: favorite artists or labels; liked or disliked genres; track listings; grouped tracks in the form of albums or play lists; and, user commentary or ratings on any of artists, labels, albums or tracks.

The user may be able to select data fields which can be made available to any users, to selected users, or else which may be accessed only by themselves.

Upon successful registration, a user may be sent user identification media by the service provider, typically in the form of user identification card 12 described in relation to FIG. 1, or any other suitable media described above. In an alternative embodiment, the service provider may issue a number of user identification cards to an event or venue which can be distributed to potential users of the system. Those individuals can later register to use the service in order to record and/or activate the card they have received.

The service provider may store a unique identifier to the media prior to sending it out to the user. After resignation, the unique identifier allows the user to be recognized by the service provider without the need for transmission of personal or sensitive user profile data over a network.

The service provider web site will typically provide a forum for communication of messages and other information and data or executable files between users, such as text and/or media files.

A client may or may not be registered as an individual user. A client may access the service provider's web site to create an entry for a venue or event which is accessible to registered users and other clients. In one embodiment, the entry for the client's event or venue may be made available to non-registered users, although, in such an embodiment, access to certain operations may be inhibited until the user registers their profile with the service provider.

It is an important consideration that the client hardware must be associated (i.e. registered) with a venue in order to allow the creation of a unique web page for an event.

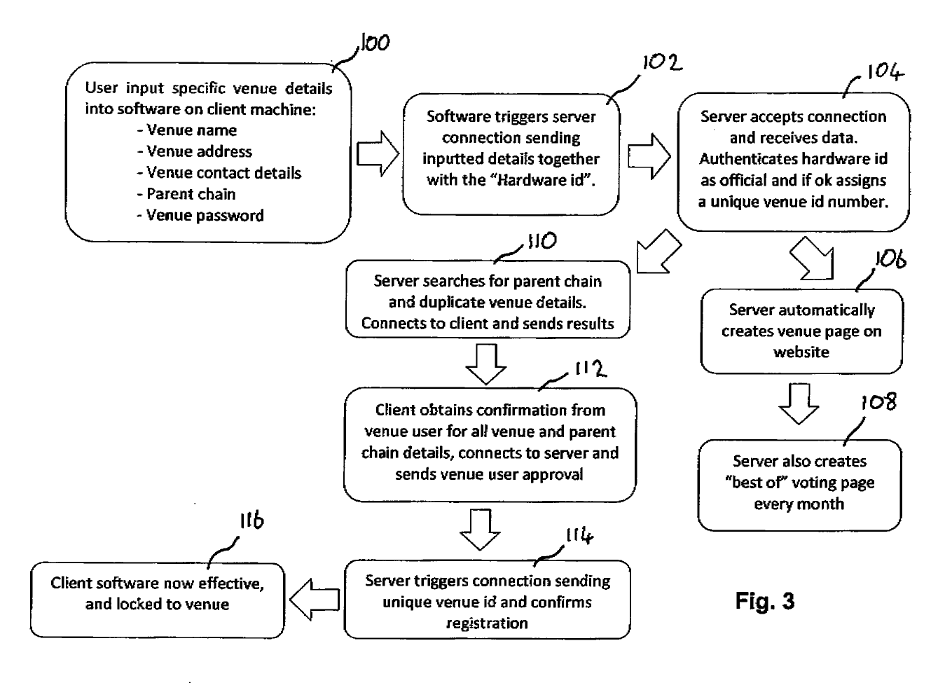

One embodiment, in which the invention allows for creation of an client venue or event page and interaction therewith by users, will now be described with reference to FIGS. 3 to 7.

FIG. 3 generally shows the steps involved in the registration of hardware in order to automatically create an entry which is accessible within a social network in the form of a customized web page for an event or venue. The following description proceeds in relation to a venue in particular. However, it will be appreciated that the same procedure may equally apply for an event at a venue.

In this embodiment, it is intended that a venue is first registered by an owner, manager or other authorized employee of the venue such that an official venue web page is created by the service provider for access online. Only once a compulsory initial registration process has been undergone by the venue can events be registered at that venue. For an event which occurs at multiple venues, the process may require a registered client in respect of each individual venue to register or accept the entry for the event at their venue before that event becomes active or listed for the venue.

The following system helps to ensure that an event resource is only created by an employee or owner/manager of a registered venue at the actual venue itself. This allows only a single, genuine event page to be created by a venue for an event, which of significant benefit in ensuring that attendees of an event make use of a single, universal resource.

At 100, a user inputs details of a venue using an user interface which runs on, or is accessible via, a suitable user computing means 40 located at, or otherwise associated with, a venue to be registered. The computing means may or may not be previously registered with the service provider for an individual user. In an alternative embodiment, the user may register a venue using bespoke computer hardware 26 which may previously have been provided by the service provider. In the case that bespoke hardware is provided, the server 26 may be connected to (or built into) a touch-screen 28 providing an onscreen keypad, which is connected to or integral with a user identification means 18. In such an embodiment, venue registration and event creation is undertaken by the computer hardware used to administer the event, the address of which is stored by the service provider. This can increase the speed and ease in which an event can be created without the need to manually log in to the social network using another computer 40.

Any or any combination of the criteria listed at 100 may be required for input by the user at this stage of the registration process. The venue address typically means the postal address or other registered address for correspondence to the venue.

Upon acceptance of the input information by the user at step 102, the software triggers transmission of a data packet to the network address of the service provider server 36. The data packet may comprise data relating to any of the criteria listed at 100 as well as data identifying the hardware and/or network address for the user computing means.

The server 36 receives the transmitted data at 104 and authenticates the user or client hardware. If accepted the service provider assigns a unique venue identifier to the hardware which may comprise an alphanumeric string or other suitable code.

A beneficial feature of the present invention is that the service provide automatically creates a customized web page for the venue at 106 according to a predetermined template. Thus the service provider software controls the creation of web page, providing for a predetermined user interface, and populates any fields for the web page for which the relevant data has been submitted by the client. Such a standardized format can allow for upload of media files to the server 36 by the client so as to customize the client web page. Thus the venue page can be customized and updated in a manner similar to that of an individual user's profile data.

A registered client and owner of an event can typically customize any aspect or field of the web page within the framework of the predetermined page format. Other types of user may be able to upload or download certain data dependent on permissions as will be described below.

Once the initial web page for the venue is created, the service provider hardware also creates a “best of” or ranking page at 108, at which registered users can vote on different events or individual aspects of each event, such as photographs, music, performers or other aspects of the venue.

If a parent chain or other valid venue details are entered by a user at 100, upon receipt of the relevant data by the server 36, the service provider hardware is controlled at 110 to search for duplicate venue details which already exist within the data store 38. In the event that a match is found at 110, the service provider hardware generates and sends a return message to the client who is the owner of the venue account via server 36, detailing the user request and matching results already stored. This may occur for example, when registering a venue which is commercially or otherwise linked with another venue (e.g., for commonly owned or managed venues).

At steps 112 to 116, the client 112 is required to obtain any permissions, if necessary under the parent chain relationship, and approve the venue user request. Upon approval, the server 36 send the necessary venue ID to the venue user and confirms registration of the venue at 114. Thus the venue user has access to software functionality associated with the venue.

Whilst the present invention is intended to allow creation of web pages for a venue in particular, it may also serve as a tool via which promoters can communicate with nightclubs and other venues to obtain permissions for events and the like.

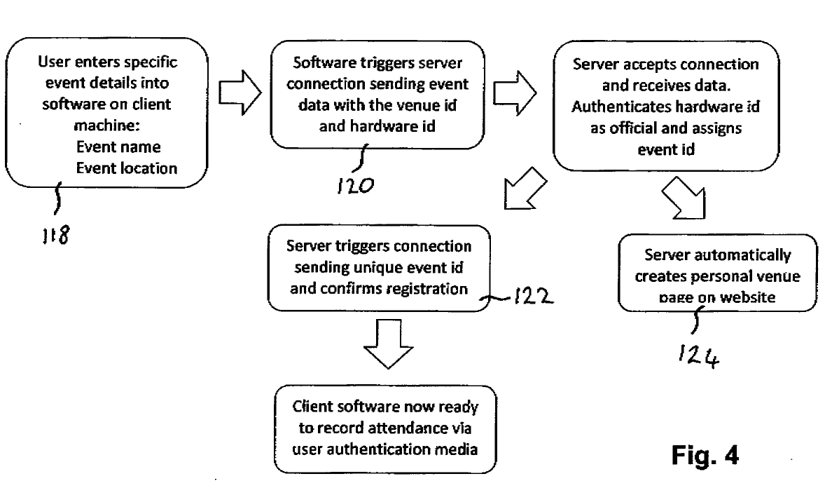

Once the venue is correctly registered with the service provider, they will then have the ability to register events at that venue. The creation of an event by a venue is recorded by the service provider as will be described below in relation to FIG. 4, such that a user's attendance at a registered event can be recorded via the user identification device at the venue location.

The user hardware used to register the venue may then be recognized as the client server 26 by the service provider. The service provider may provide software in order to allow the user hardware to operate as a client in accordance with the present invention. Additionally or alternatively, the service provider may provide additional computer hardware to be installed at the venue in accordance with the invention. This may comprise an alternative server 26 and/or any of the other client components described in relation to FIG. 1.

In FIG. 4, the steps in establishing registration of an event which also automatically creates an event page on a social network using the service provider hardware are shown. The page for the event and/or venue is typically an HTML page.

A focus of the present invention is on the service provider's hardware allowing client venues to physically create a standardized/universal event which can be integrated simply into an associated social network. This allows integration of certain functions with the event page to accommodate a greater level of interaction between users and event pages. The level of interaction with an event page by a registered user can be easily controlled by attributing certain permission to certain types of user. This allows definition of different types of user or account with varying attributes, awards and permissions being assignable to each type.

The registered venue enters details of the event to be registered at 118 using a pre-registered computing device having the relevant software functionality and permissions in place. The relevant data is sent to the service provider at 120 including the venue ID and hardware ID for authentication at server 38. The hardware ID is typically a unique serial key embedded within client hardware, which can be used to authenticate all client-server connections. Once the details are authenticated by the service provider, it assigns an event ID to the requesting user which is sent to the user along with confirmation of the registration of the event at 122.

The service provider will typically store a location/address for the client server either within, or else along with, the hardware ID such that any event creation request for a venue will be verified to check that it has originated from the registered client hardware address.

At 124, an event web page is automatically created for the event in a manner similar to the venue page creation described above. The event web page may become active immediately or else may be activated by the event creator once they have had opportunity to upload any media or information to the page as required.

The registration of the event and the creation of an event entry or log allows for attendance of the event to be recorded by registered individual users. The location (venue) and time and date of an event may be used as parameters to determine attendance by users. Thus, when users log attendance at an event by logging their identification media using reader device 18 at a venue, an attendance record can be automatically sent to the service provider by server 26 at the venue.

Any events registered for a venue are linked with the corresponding single venue page at the service provider. Thus the event page is easily accessed by the corresponding venue page and vice versa. This hierarchical system is also beneficial in ensuring that attendance at an event is correctly assigned to the correct venue. In this manner a registered venue can create multiple events for that venue. The system may also encourage communication between venues in order to obtain the relevant permissions if related events are to be staged at multiple venues.

In one embodiment, a venue or else the associated client hardware can only be registered for one event at a time. Thus the service provider and/or client software may check for overlapping event times entered by a venue. In the event that an overlap is determined, the user may be presented with a message to indicate that overlapping events are not permitted and to re-enter the relevant event times.

If a user attempts to register an event at a venue for which they are not the registered client or owner, the service provider may send a message to the registered venue indicating that a request for an event has been received. The venue owner may then accept or reject the event registration against their venue.

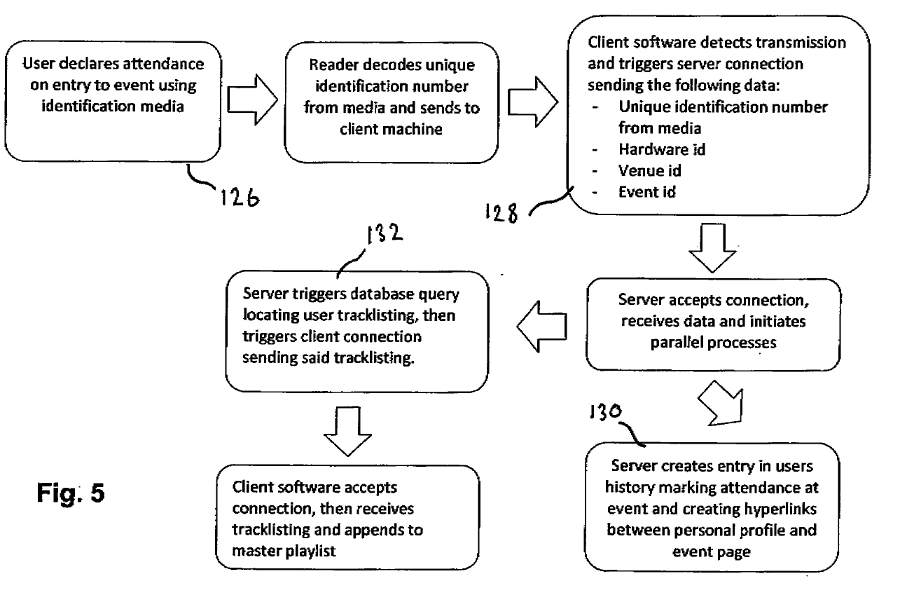

In FIG. 5, the embodiment of a swipe card hardware system is described which is able to automatically retrieve and combine multiple users' individual music-preference databases in to one master database. As described above, any alternative suitable user identification media and associated reader may be used in place of the swipe card system.

It will be appreciated that the steps of FIG. 5 is only made possible when a venue and event have been correctly registered in accordance with, for example, the embodiments of FIGS. 3 and 4.

At 126 the user swipes into the event using a reader 18 at the venue. The reader 18 decodes the user ID string from the swipe card and communicates the decoded data to the client machine 26. The software on the client machine 26 is primed to send a data transmission to the service provider machine 36 comprising data representative of the information shown in box 128. The connection to the service provider and the transmission of the relevant data may be automatic or else may require manual permission from the client.

When the data is received by the service provider, a plurality of functions are undertaken by the service provider hardware which may be considered parallel processes.

At 130 the service provider creates a log in the user's event history for their personal profile which notes their attendance of the event. This may generate a visual acknowledgement of attendance on the user's profile page. A hyperlink may also automatically be generated on the user profile page, linking to the event page. A search may first be conducted of the events to which the user has already linked to determine whether or not a new link should be created for that user. This allows a user to visit the event page simply after the event.

The service provider may store a log of the user's event history against their profile data.

At 132 the service provider also initializes a database query to search the data store for music preferences stored for the registered user against their profile. The music preference data may relate to track listings or rankings or any other music-related information stored against the user's profile as described above. Once determined, the data pertaining to the user's music preferences are sent by the service provider to the client server by a data signal transmission. The service provider may select only a recent user track listing from a user's total track listings for transmission to the client, such as for example tracks listed or rated or revisited in the previous month.

Once received by the client server, the music preference data is appended to common lists or records created for all the users registered as attending the event. The common records can be considered to comprise master arrays or lists. In one example, a master playlist can be created comprising the songs which appear most frequently in the registered attending user's track listings. Additionally or alternatively, master lists can be created for the most popular music genres, sub-genres, artists or the like all of which can be presented on screen 28 to a performer or organizer. Account for user ratings stored against their user profile may also be taken into account such that the determination of master lists are weighted more closely to user tastes.

In one embodiment, the master list may automatically determine lists of songs to be played and may cue the relevant songs in order where they are available on a local storage device such as, for example, by way of stored media files on hard disc. It is envisaged that a disc jockey or event organizer may override the suggested playlist if desired with their own choice of music. Alternatively, the cueing and playing of the tracks may be entirely automated such that little or no manual intervention is required.

The benefit of this aspect of the invention is that a user attending an event is more likely to hear music influenced by their own personal preferences. When such a benefit is carried across a proportion of the total attendees of an event, it can have a significant impact on the atmosphere at an event and the event can prove more enjoyable and successful for attendees and organizers alike.

It is important to note that other user profile data such as user ID, name or other sensitive data is not required to be transmitted either to or from the client machine. Thus the anonymity of the user is preserved and the system is guarded against fraudulent or other unintended use.

A user can swipe into as many event as they like within a given time period to represent their actual movements and attendance of events over any period of time. For example, a user may register attendance at two or more events in one night. However, a user may only validly register attendance at a particular event once. If a user attempts to register a second time for the same event, the hardware will check the current attendance record and acknowledge that the user is already in attendance. Thus that user's music preferences will not be taken into account more than once when compiling the master playlist.

For the embodiment described above in relation to FIG. 5, it is important that multiple concurrent or overlapping events cannot be registered for a venue. In this way, everyone who registers attendance at a venue within given time limits is recorded against the current event. An event may automatically be determined to be finished at the time previously entered when the event entry is created by the venue. However, it is in many ways preferred that an event may be concluded only when the venue deems that event to be finished by terminating the event on the client hardware. An option to end the event may be provided in the client user interface for this purpose.

The termination of the event subsequently wipes the event data and the associated music preference data accumulated during the event from the client hardware ready for a fresh new event. This process ensures that new events are regularly created and that music preference data from previous events are not accidentally left interfering with new accumulating data for a subsequent event. However, the amassed attendance, music preference and any other event data are typically not automatically deleted from the service provider memory 38. Instead the event is recorded as ended such that no new attendance data can be recorded and the amassed data is stored against the terminated event log for subsequent access by the service provider.

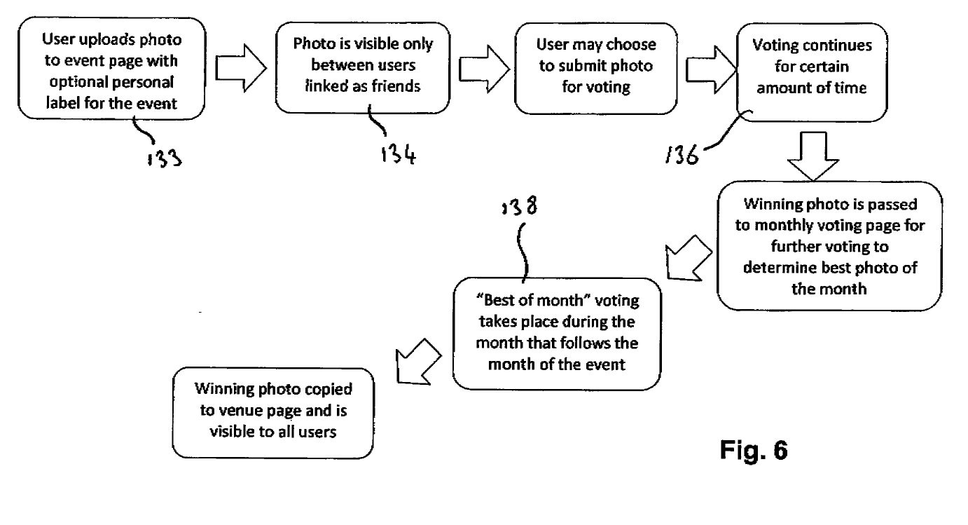

In FIG. 6, it is shown how a user can upload media to an event page for an event which they have attended. The user can typically access the event page using a hyperlink generated on their user profile page by the service provider upon attendance to the event. A user can then upload media files at 133 to the service provider via their computer 40 for storage against the event page such that other registered users who attended the event or else who are listed as friends of the user can view the files at 134.

The relevant media may comprise photographs taken at the event, stories about the event, video files, audio commentary or the like.

Once uploaded, the media file may be initially accessible to users listed as friends or otherwise linked to the user's profile. However, the user may choose to allow others to access the media for the purpose of review, voting and/or rating of the content of the media file. As other users rate or vote on the media content over a predetermined time period at 136, a log of votes can be amassed against that entry by the service provider.

The most popular media uploaded for an event or number of events can be entered into further voting stages at 138 in which the media is ranked against media uploaded from other events or venues. For example, the “photo of the month” may be determined for a venue or series of events or even for a geographical area such as a town, city, state, county or country in which a plurality of venues are located. The most highly rated media may be posted on the venue web page or else a further page created by the service provider. The winning user may be acknowledged, providing their consent has been obtained.

Whilst it is envisaged that all registered users may have the ability to upload media to the event pages, this capability may be inhibited until certain user criteria are fulfilled. The criteria may comprise attendance of a predetermined number of events or else submission of certain predetermined fields of user information to the service provider for storage against a user profile. In addition, the ability for uploading media may be removed in the event that abusive or offensive material is uploaded by a user.

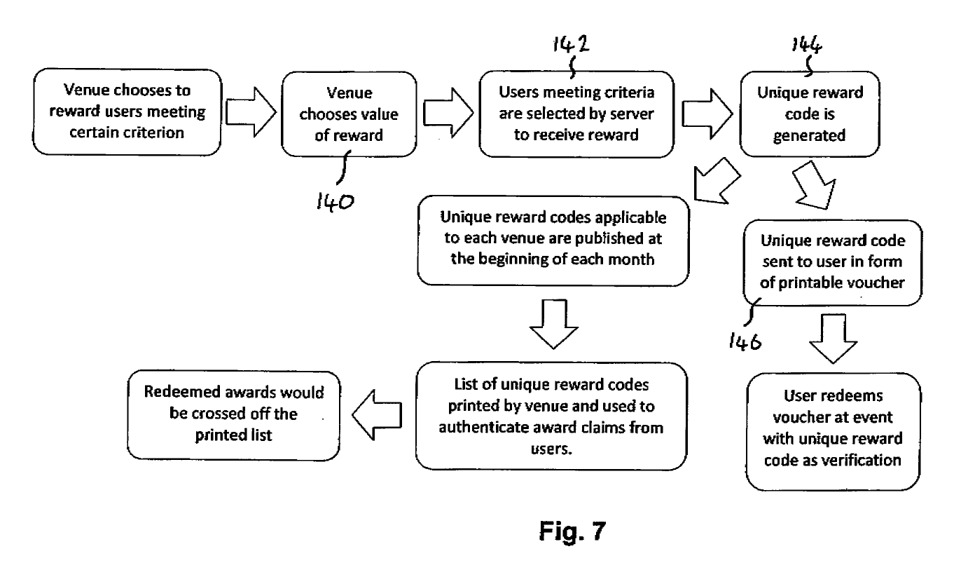

The most popular uploaded media can be recorded and rewards provided by the service provider and/or client as explained in FIG. 7. Even if a reward is offered by the client, it will typically be administered by the service provider to ensure confidentiality of user details are preserved.

In FIG. 7, the criteria for the reward and the value or type of reward is determined by the service provider at 140. The criteria may comprise numbers of votes, ratings, number of uploads, numbers of events attended or the like. The service provider searches the user records to determine the users which meet the selected criteria at 142 and issue a unique reward code to each selected user at 144.

The reward codes may be sent to the relevant users at 146 such that they can be redeemed at any participating venue or else online. One example comprises the use of a printable voucher, which a user can present as verification of the right to claim their reward. The user may also be required to confirm their reward code to claim their reward.

Additionally or alternatively, reward codes may be published or sent out to participating venues once awarded at step 148. A user may then claim their reward from the venue upon presentation of the printable voucher and/or their reward code. A venue can then remove the reward code from their list once it has been claimed such that it cannot be reused.

Thus the present invention can offer the optional service for venues to be able to offer benefits to users without the need to acquire the personal details of the recipient.

In view of the above description, certain embodiments of the present invention provide for a number of features and advantages as follows:

The system allows users to effortlessly and automatically log into their social network, contribute their track listing and as result log their attendance. The system can help reduce the need for expensive promotion of events in order to tell people what music is being played at venues or which performer is appearing. The system allows users to contribute their music tastes to a venue's master playlist for an event.

In addition to heightening the enjoyment of the event by submitting the track listings, users also benefit when they next log into their social network profile since a common point of reference for the event is provided.

In its simplest form, the present invention does not require content streaming for music listings to be acknowledged at an event. It merely requires tracks, albums, artists and/or genres to identified by names or other alphanumeric identifiers, and upload of the music by users is not required.

The concept allows an automated login to a social network to retrieve a user's track listing without dissemination of sensitive user profile data and without requiring access to the full user profile for social networking purposes. Many other conventional systems do not provide this automated login and users of such systems have to manually input their login information to access their account.

The system is able to accurately log who has actually been to a venue, without the inaccuracy or uncertainties of other location-based service technologies, such as GPS. This provides for predictable and robust system which is suitable for implementation of a reward system without fear of errors or inconsistencies. The ability for actual venues or clients to reward attendees is considered advantageous such that rewards, which are likely to be relevant and appreciated by users can be administered.

Unlike conventional tracking systems, the invention does not require significant computing power or resources in monitoring individual's locations. It can simply determine attendance of an event without creating logs of user's whereabouts at any other times.

What is claimed is:

1. A system for administering data by a service provider, said data pertaining to attendees of an event hosted at a venue, the system comprising:
a data store and a network connection associated with the service provider, the data store comprising profile data for a plurality of users;
user identification media issued to a user upon registration of user profile information with the service provider, the media being capable of carrying user identification data thereon;
electronic apparatus for location at the venue, comprising a reader device capable of determining user identification data carried by said user identification media, wherein the reader device has a signal transmitter associated therewith for transmission of an identification data signal to the service provider upon determination of a user's identification data;
wherein, the service provider is arranged to search said data store for profile data relating to the identified user upon receipt of said identification data signal and to transmit a return data signal to said electronic apparatus, said return data signal comprising music preference data retrieved from said user profile data; and
the electronic apparatus at the venue being arranged to compile received music preference data from the service provider into one or more arrays of compiled data.

2. A system according to claim 1, wherein the compiled music preference data is arranged in one or more lists arranged to be presented on a display screen.

3. A system according to claim 1, wherein the compiled music preference data comprises one or more arrays of songs, details of which are stored by the service provider, and said one or more arrays of compiled data comprise a master list of songs displayed to a disc jockey.

4. A system according to claim 1, wherein the service provider is located remotely of said venue and is connected to said electronic apparatus at said venue via a network.

5. A system according to claim 1, wherein the user identification data is stored on said user identification media in an encoded format and said reader device is arranged to decode said user identification data.

6. A system according to claim 1, wherein the electronic apparatus at the venue records the time and date at which the reader device determines the user identification data on said user identification media and transmits said time and date and an identification of said venue to the service provider with said identification data signal.

7. A system according to claim 1, wherein an event at said venue is pre-registered with the service provider by a client for a predetermined time period and details of which are stored at said data store, such that the receipt of said identification data signal by the service provider determines the attendance of the identified user at a pre-registered event.

8. A system according to claim 7, wherein the service provider is arranged to store a log of the attendance of a user at said event against the user's profile data on said data store.

9. A system according to claim 7, wherein the service provider is arranged to associate a hyperlink to a web page for the pre-registered event with the user's profile data upon determination of attendance of said user at said event.

10. A system according to claim 7, wherein the service provider is arranged to automatically generate a web page for said event and to make said web page accessible over the internet via a server upon registration of said event by said client, said web page being generated according to a predetermined template.

11. A system according to claim 7, wherein the registration of said event with said service provider is dependent upon authorization of said event by a pre-registered owner or administrator of the venue at which the event is to be held.

12. A system according to claim 1, wherein the user identification media comprises a card having at least one of a magnetic material and a bar code thereon.

13. A system according to claim 1, wherein the user identification media comprises a user identification code, said code being stored on said data store against the user's profile data and the user identification signal comprises said code but no additional data identifying said user.

14. A system according to claim 7, wherein a pre-registered event has a web page associated therewith by said service provider and a user is authorized to at least one of upload media files and submit text to said event web page only, once attendance of said event by said user has been determined by said service provider.

15. A system according to claim 7, wherein a pre-registered event has a web page associated therewith and said service provider administers a plurality of levels of authorization to allow varying degrees of interaction with said web page by said users.

16. A system according to claim 1, wherein a user submits profile data to said service provider using a PC connected to a network, said PC comprising software for determining music preferences of said user by monitoring music files accessed and played by a user on said PC.

17. A system according to claim 16, wherein data pertaining to said determined music preferences is uploaded to the service provider automatically upon accessing of the user profile by said user.

18. A system according to claim 14, in which the service provider establishes a voting system for an event web page via which registered users may vote or rank the content of media files uploaded to event web sites by other users.

19. A system according to claim 18, in which the service provider administers a reward system for users responsible for uploading media which meet predetermined reward criteria.

20. A system according to claim 19, in which the service provider creates a unique reward code for a user upon determination that said predetermined reward criteria have been met and communicates said reward code to at least one of said user and a client responsible for a venue or event.

21. A method for administering data by a service provider, said data pertaining to attendees of an event hosted at a venue, the method comprising:
providing a data store and a network connection, the data store being arranged to store profile data for a plurality of users;
allowing a plurality of users to register user profile data so as to create a user registration on said data store;
issuing user identification media to a user upon registration of user profile data, the media being capable of carrying user identification data thereon;
providing electronic apparatus the venue comprising a reader device capable of determining user identification data carried by said user identification media, wherein the reader device has a signal transmitter associated therewith;
transmitting an identification data signal to the service provider upon determination of a user's identification data;
checking said data store for profile data relating to the identified user upon receipt of said identification data signal;
transmitting a return data signal to said electronic apparatus, the return data signal comprising music preference data retrieved from said user profile data; and,
compiling received music preference data at the venue from the service provider into one or more arrays of compiled data.

22. Electronic apparatus for location at a venue remote from a service provider and arranged to communicate with said service provider via a network, said electronic apparatus comprising:
a reader device capable of determining user identification data stored on a user identification media carried by a user;
a signal transmitter associated with the reader device for transmission of an identification data signal to the service provider upon determination of a user's identification data;
wherein, the electronic apparatus is arranged to receive a return data signal from said service provider comprising music preference data pertaining to said user identification data and to compile said received music preference data into one or more arrays of compiled data.

23. Media comprising:
machine readable code for control of an electronic apparatus located at a venue at which an event is to be held;
said electronic apparatus comprising a reader device capable of determining user identification data stored on a user identification media carried by a user, and a signal transmitter associated with the reader device;
said machine readable code comprising instructions to control the signal transmitter to transmit an identification data signal to a remote service provider upon determination of authorized user identification data by said reader device;
and to control said electronic apparatus to receive a return data signal from said service provider comprising music preference data pertaining to said user identification data and to compile said received music preference data into one or more arrays of compiled data for display to an event administrator or performer.

24. A method for creating and administering a web page for an event by a service provider comprising:
providing a data store and a network connection associated with the service provider,
receiving profile data from a plurality of users and registering said profile data against an entry for said user;
issuing user identification media to a user upon registration of user profile data at said data store, the media being capable of carrying user identification data thereon
receiving event registration data from an event organiser and automatically generating an event web page according to a predetermined template;
making said web page available only to users having registered profile data at said data store; and,
providing a data reader device at said event location for logging attendance of the event by users having said issued user identification media; and,
logging attendance of a user at said event against that user's profile data.

25. A method according to claim 24, further comprising the step of authorizing a user to upload content to said event web page only once a log of attendance of said user at said event has been generated.
